(19) United States
(12) Patent Application Publication
(10) Pub. No.: US 2005/0173316 A1
(43) Pub. Date: Aug. 11, 2005

(54) Filtering cell with compound slope

(76) Inventor: Gene Pleus, Thonotosassa, FL (US)

Correspondence Address: DENNIS L. COOK, ESQ.;THE LAW OFFICES OF DENNIS L COOK PLLC, 12718 DUPONT CIRCLE, TAMPA, FL, 33626, US

(21) Appl. No.: 11/050,241

(22) Filed: Feb. 3, 2005

Related U.S. Application Data
(60) Provisional application No. 60/541,418, filed on Feb. 3, 2004.

(51) Int. Cl. B01D 24/38

(52) U.S. Cl. 210/109; 210/247; 210/291; 210/293

(57) ABSTRACT

The filtering cell, according to this invention, includes a tank having a base wall and a filter bed supported above the base wall which divides the tank into an upper compartment for receiving a substance to be filtered and a lower compartment for receiving a filtrate. The improved filter pan disclosed in this application has a compound slope, that is, the drainage of the filter bed is towards the center of the filter pan into the drainage channel and also toward the outlet orifice. This compound slope is made possible by the drainage channel also having an incline toward the outlet orifice.

### CROSS-REFERENCE TO RELATED APPLICATION

The present application claims the benefit of previously filed co-pending Provisional Patent Application, Ser. No. 60/541,518, filed Feb. 3, 2004, and incorporates by reference the contents therein.

### BACKGROUND OF THE INVENTION

This invention relates to filtering cells used in the vacuum filtering of industrial sludges.

Continuous filters with horizontal filtering surfaces for filtering industrial sludges are often mounted on a carousel or turntable and tilt about an axis during their revolution for discharge of the filtration cake after the filtrate is filtered from the sludge. Prior art cells of this type are shown in U.S. Pat. Nos. 3,216,576; 3,389,800; 3,830,658; 4,172,791; and 4,330,404. The latter two patents disclose filtering cells which improve the efficiency of filtrate removal as compared to the '658 patent.

In these prior art filtering cells, a filter bed is supported within a tank dividing the tank into an upper compartment for receiving a substance to be filtered and a lower compartment for receiving a filtrate. A base wall forming the bottom of the tank includes a drainage channel extending over the entire length of the cell and bordered over its entire length by two inclined planes. Because individual filtering cells are mounted in close proximity to one another and must be able to tilt, it is important for the ratio of the depth of the cell to the filtering surface area to be as small as possible. Thus, the filters are rather flat, restricting the slope of the drainage channel to a small angle, namely, approximately 1 to 2 degrees. Further, since the planes flanking the drainage channel incline toward one another, when flows from the planes merge at the drainage channel, their velocities are equal and opposite so that the merged fluid has low velocity towards the filtrate outlet at the drainage channel. Flow stagnation results at the top end of the drainage channel which the shallow slope of the drainage channel has difficulty in overcoming. U.S. Pat. No 5,087,363 discloses a filter cell where the base wall includes an additional inclined end section at the top end of the filter cell in an attempt to alleviate this problem but the prior art configurations still restrict fluid flow through the filter cell.

### SUMMARY OF THE INVENTION

The filtering cell, according to this invention, includes a tank having a base wall and a filter bed supported above the base wall which divides the tank into an upper compartment for receiving a substance to be filtered and a lower compartment for receiving a filtrate. The novel aspect of the improved filter pan disclosed in this application is that there is a compound slope, that is, the drainage flow of the filter bed is towards the center and also towards the outlet orifice.

The object of the embodiments of the present invention is to promote the unhindered flow of liquids from the top to the bottom of the filtering cell so that the outlet orifice absorbs the liquids with a maximum flow rate, this state being maintained for as long as possible.

### BRIEF DESCRIPTION OF THE DRAWINGS

The following figures set forth the preferred embodiment of the present invention:

FIG. 1 is a diagrammatic plan view of a filtering cell according to the invention;

FIG. 2 is a side plan view of the filtering cell according to the invention;

FIG. 3 is a cross sectional view of the bottom end of the filter cell;

FIG. 4 is a cross sectional view of the top end of the filter cell;

### ITEMS OF THE FIGURES

1. Tank
2. Base Wall
3. through 6. Lateral Walls
7. Filter Bed
8. Ribs
9. Upper Compartment
10. Lower Compartment
11. Outlet Orifice
12. and 13. Lateral Flow Off Sections
14. Drainage Channel
15. Openings in Ribs
16. Axis of filter cell
17. Removal Duct
18. Top end of Drainage channel
19. Bottom end of Drainage channel

### DESCRIPTION OF THE PREFERRED EMBODIMENT

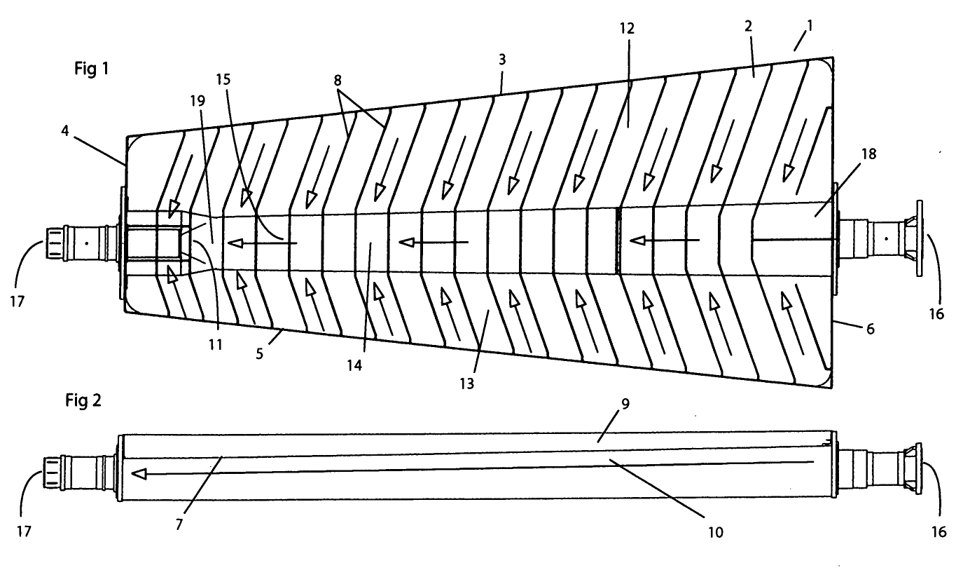

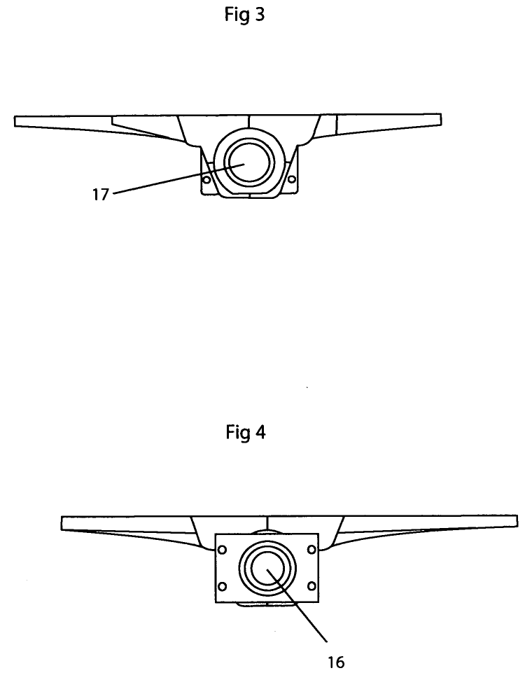

With reference to FIGS. 1-4, a filtering cell according to the preferred embodiment of the invention includes a tank (1) having a base wall (2), lateral walls (3-6) extending upwardly from the base wall (2), and an upwardly facing opening. As shown in FIG. 1, the cell has an approximately trapezoidal shape, or the shape of a sector of a polygon, and this shape is selected because the cell is designed to be arranged beside other similar cells so as to form a continuous filtering device rotating in the manner of a turntable. Such devices are known and described in U.S. Pat. Nos. 3,830,658; 4,172,791; and 4,330,404, cited above. It should be understood that the filtering cell according to the invention is limited neither to this form nor to use in such equipment.

The tank (1) of the filtering cell contains a filter bed (7) shown in the figures. Such a filter bed (7) is known, for example, in the above-cited patents, and it is generally composed of a support mesh (not shown) on which a sheet of filter cloth (not shown) rests. The support mesh is itself supported in a known manner by ribs (8) which extend substantially transversely to the cell and which serve simultaneously as stiffeners for the filtering cell.

The filter bed (7) divides the tank (1) into an upper compartment (9) for receiving the substance to be filtered and a lower compartment (10) for the filtrate. An outlet orifice (11) is provided at the bottom of the lateral wall (5) for removal of the filtrate through a removal duct (16).

The base wall (2) of the tank (1) comprises two lateral flow-off sections (12 & 13) arranged on either side of a drainage channel (14) and inclined in a compound manner downwards toward the drainage channel (14) and also towards the outlet orifice (11). These lateral flow-off sections (12 & 13) thus form two compound inclined planes which start from the base of the lateral side walls (3 & 5) of the tank. Each of the flow-off sections (12 & 13) has a compound slope oriented partly to the drainage channel (14) and partly to the outlet orifice (11). The drainage channel (14) has a base inclined between its top end (18) and its bottom end (19) downward towards the outlet orifice (11). In the region of the drainage channel (14) and laterally to it, the support ribs (8) of the filter bed (7) have openings which permit the passage of liquids in the longitudinal direction of the tank (1) and, where necessary, the passage of gas.

The filtering cell of the invention is designed to be tilted about an axis (16) to facilitate the removal of cake filtered substance at the end of the treatment. Bearings located on the axis (16) and the removal duct (17) support the cell for pivoting about its axis (16).

As is clearly shown in the figure FIG. 2 embodiment, the filter cell is fixed in a continuous slope from the top end of the drainage channel (18) to the bottom end of the drainage channel (19). The ribs (8) force the filtrate to flow expeditiously from the two lateral flow off sections (12 & 13) to the drainage channel (14) where the filtrate then flows through the openings in the ribs (15) toward the outlet orifice (11). Therefore, the upper compartment (9) of the filter cell is filled with sludge to be subjected to a solid/liquid separation, the filtrate flows into the lower compartment (10) with the application of partial vacuum being applied to the compartment (10) if necessary. On the lateral flow off sections (12 &13) the liquids flow in a direction toward the drainage channel (14) and also towards the bottom end of the drainage channel (19). Thus all of the filtrate travels more quickly towards the outlet orifice (11) and through the removal duct (17).

Although this invention has been described in the form of a preferred embodiment, many modifications, additions, and deletions, may be made thereto without departure from the spirit and scope of the invention, a set forth in the following claims.

1. A filtering cell comprising:
a tank;
said tank including a base wall and having a filter bed supported above the base wall thereby dividing the tank into an upper compartment for a substance to be filtered and a lower compartment for the collection of a filtrate;
said base wall longitudinally inclined and adjoiningly aligned with an inclined drainage channel placed longitudinally down the center of said base wall wherein both said base wall and said inclined drainage incline in the same direction; and,
said base wall having transversely inclined flow off sections arranged on either side of said inclined drainage channel.

2. The filter cell according the claim 1, wherein the slope of said inclined drainage channel is fixed.

3. The filter cell according to claim 1, wherein said inclined drainage channel comprises of one constant slope throughout the length of said inclined drainage channel.

4. The filter cell of claim 1, wherein said lateral flow off sections flow directly to said inclined drainage channel.

5. The filter cell of claim 1, wherein said inclined drainage channel and said lateral flow off sections have different slopes.

6. The filter cell of claim 1, wherein said inclined drainage channel is parallel to the filter bed.

7. A filtering cell comprising:
a tank having a base wall;
lateral walls extending upwards from said base wall creating an upwardly facing opening;
a filter bed supported in the tank and dividing said tank into an upper compartment for a substance to be filtered and a lower compartment for a filtrate;
an outlet orifice for the filtrate, provided at a bottom end of one of said lateral walls;
said base wall of said tank comprising two lateral flow off sections arranged on either side of a drainage channel wherein said lateral flow off sections are transversely inclined towards said drainage channel and longitudinally inclined towards said outlet orifice;
said drainage channel having a base inclined longitudinally downward from the top end of said drainage channel to the bottom end of said drainage channel; and,
said bottom end of said drainage channel opening out into said outlet orifice.

8. The filtering cell of claim 7 wherein the longitudinal slope from said top end of said drainage channel to said bottom end of said drainage channel is approximately the same as the overall longitudinal slope of said lateral flow off sections.
